(19) United States
(12) Patent Application Publication
(10) Pub. No.: US 2018/0018385 A1
(43) Pub. Date: Jan. 18, 2018

(54) SYSTEM, DATA COMBINING METHOD, INTEGRATION SERVER, DATA COMBINING PROGRAM, DATABASE SYSTEM ,DATABASE SYSTEM COOPERATION METHOD, AND DATABASE SYSTEM COOPERATION PROGRAM

(71) Applicant: Kabushiki Kaisha Toshiba, Minato-ku (JP)

(72) Inventors: Taiga KATAYAMA, Ota (JP); Kei YAMAJI, Kunitachi (JP)

(73) Assignee: Kabushiki Kaisha Toshiba, Minato-ku (JP)

(21) Appl. No.: 15/630,358

(22) Filed: Jun. 22, 2017

(30) Foreign Application Priority Data
Jul. 12, 2016 (JP) 2016-137743

(51) Int. Cl. G06F 17/30

(52) U.S. Cl. CPC G06F 17/30598; G06F 17/3033

(57) ABSTRACT

The first DS in accordance of the inquiry from the integration server, extract first data from the first DB and generate a first hash value based on the first data. The second DS in accordance of the inquiry from the integration server, extract second data from the second DB and generate a second hash value based on the second data. The first DS transmits the first hash value to the second DS. The second DS collates the first hash value with the second hash value, transmits, to the integration server, a collation result and at least a part of the second data, for which the first hash value and the second hash value are matched, and transmits a matched part of hash values to the first DS. The first DS transmits at least a part of the first data that was a source of the matched part of hash values to the integration server. The integration server combines the data received from the first DS and the second DS on the basis of the collation result. The first DS in accordance of the inquiry from the integration server, extract first data from the first DB and generate a first hash value based on the first data. The second DS in accordance of the inquiry from the integration server, extract second data from the second DB and generate a second hash value based on the second data. The first DS transmits the first hash value to the second DS. The second DS collates the first hash value with the second hash value, transmits, to the integration server, a collation result and at least a part of the second data, for which the first hash value and the second hash value are matched, and transmits a matched part of hash values to the first DS. The first DS transmits at least a part of the first data that was a source of the matched part of hash values to the integration server. The integration server combines the data received from the first DS and the second DS on the basis of the collation result.

### BACKGROUND OF THE INVENTION

### Field of the Invention

Embodiments of the present invention relate to a system, a data combining method, an integration server, a data combining program, a DS (database (DB) system), a DS cooperation method, and a DS cooperation program.

### Description of Related Art

A technique called a semi-join method in which a plurality of data servers cooperate to combined data on the basis of a query received from a client and transmit responses to the client is known. In a hash semi-join method, if a query has been received from a client, a hash value of column data to be combined is transmitted from a first DS to a second DS. The second DS collates the received hash value with a hash value of its own column data and returns a combining result including identification information of a row corresponding to the matching hash value and column data for extracting row data to the first DS. The first DS generates a final result by combining the row data on the basis of the combining result and transmits the final result to the client. However, if a size of the column data transmitted from the second DS to the first DS is large, an amount of communication between the DSs is likely to increase.

An example of the related art is Japanese Unexamined Patent Application, First Publication No. 2007-26296

### SUMMARY OF THE INVENTION

An objective of the present invention is to provide a system, a data combining method, an integration server, a data combining program, a DS, a DS cooperation method, and a DS cooperation program capable of executing a process of combining data between different DSs at a higher speed.

A System of an embodiment includes a plurality of DSs and an integration server. The plurality of DSs comprises a first DS that configured to manage a first DB and a second DS that configured to manage a second DB. An integration server configured to transmit an inquiry to the first DS and the second DS based on a request for combined data from a client. The first DS in accordance of the inquiry from the integration server, extract first data from the first DB and generate a first hash value based on the first data. The second DS in accordance of the inquiry from the integration server, extract second data from the second DB and generate a second hash value based on the second data. The first DS transmits the first hash value to the second DS. The second DS collates the first hash value with the second hash value, transmits, to the integration server, a collation result and at least a part of the second data, for which the first hash value and the second hash value are matched, and transmits a matched part of hash values to the first DS. The first DS transmits at least a part of the first data that was a source of the matched part of hash values to the integration server. The integration server combines the data received from the first DS and the second DS on the basis of the collation result.

### BRIEF DESCRIPTION OF THE DRAWINGS

FIG. 1 is a diagram illustrating an example of a DS 1 of an embodiment.

FIG. 2 is a block diagram illustrating an example of functional configurations of a user terminal 100, a DB integration server 200, a DS X, and a DS Y.

FIG. 3 is a diagram illustrating an outline of a combining process in the embodiment.

FIG. 4 is a flowchart illustrating an example of the overall processing flow for combining data in the DS 1 of the embodiment.

FIG. 5 is a diagram illustrating an outline of a process of generating a hash table.

FIG. 6 is a diagram illustrating an outline of a process of determining a combining base point and a combining execution point.

FIG. 7 is a diagram illustrating an outline of a process of collating hash values when the DS X is determined to be a combining base point and the DS Y is determined to be a combining execution point.

FIG. 8 is a diagram illustrating an outline of a process of transmitting a combining result when the DS X is determined to be a combining base point and the DS Y is determined to be a combining execution point.

FIG. 9 is a diagram illustrating an outline of a process of generating a final result when the DS X is determined to be a combining base point and the DS Y is determined to be a combining execution point.

FIG. 10 is a diagram illustrating an outline of a process of collating a hash value when the DS X is determined to be a combining execution point and the DS Y is determined to be a combining base point.

FIG. 11 is a diagram illustrating an outline of a process of transmitting a combining result when the DS X is determined to be a combining execution point and the DS Y is determined to be a combining base point.

FIG. 12 is a diagram illustrating an outline of a process of generating a final result when the DS X is determined to be a combining execution point and the DS Y is determined to be a combining base point.

FIG. 13 is a flowchart illustrating an example of a flow of internal processing in the DB integration server 200 according to the embodiment.

FIG. 14 is a flowchart illustrating an example of the flow of internal processing in the system cooperation device according to the embodiment.

FIG. 15 is a flowchart illustrating an example of a processing flow of a system cooperation device 300 in a DS completing creation of a hash table earlier than a partner DS.

FIG. 16 is a flowchart illustrating an example of a processing flow of a system cooperation device 300 in a DS that has received cost information from a partner DS.

FIG. 17 is a flowchart illustrating another example of the processing flow of the system cooperation device 300 in the DS that has received the cost information from the partner DS.

FIG. 18 is a diagram illustrating an embodiment of a process of generating a hash value from data obtained by extracting data from a DB.

FIG. 19 is a diagram illustrating an example of a process of determining a combining base point and a combining execution point.

FIG. 20 is a diagram illustrating an example of a process of determining a combining base point and a combining execution point.

FIG. 21 is a diagram illustrating an example of a process of collating hash values.

FIG. 22 is a diagram illustrating an example of a process of collating hash values.

FIG. 23 is a diagram illustrating an example of a process of generating an intermediate result and a final result.

### DETAILED DESCRIPTION OF THE INVENTION

Hereinafter, a system, a data combining method, an integration server, a data combining program, a DS, a DS cooperation method, and a DS cooperation program according to embodiments will be described with reference to the drawings.

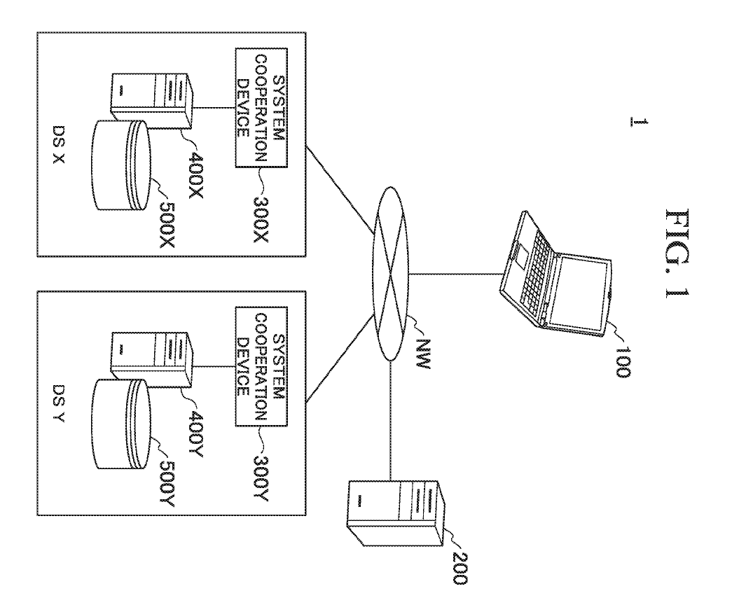

FIG. 1 is a diagram illustrating an example of a DS 1 of an embodiment. The DS 1 includes, for example, a user terminal 100, a DB integration server 200, a DS X, and a DS Y. The DS X includes, for example, a system cooperation device 300X, a DB management device 400X, and a DB 500X. The DS Y includes, for example, a system cooperation device 300Y, a DB management device 400Y, and a DB 500Y. The DSs are two DSs, that is, the DS X and the DS Y, in the embodiment, but are not limited thereto. The number of DSs provided may be an arbitrary natural number greater than or equal to two. The DS X and the DS Y manage and store data of different types of content. Also, the DS X and the DS Y are DB management systems (DBMSs) having different types of data recording formats, but are not limited thereto and may be the same DBMS.

The user terminal 100, the DB integration server 200, the DS X, and the DS Y are connected to a network NW. The network NW includes, for example, a radio base station, a Wi-Fi access point, a communication line, a provider, the Internet, and the like. Also, it is not necessary for all combinations of these constituent elements to be able to communicate with each other, and the network NW may partially include a local network.

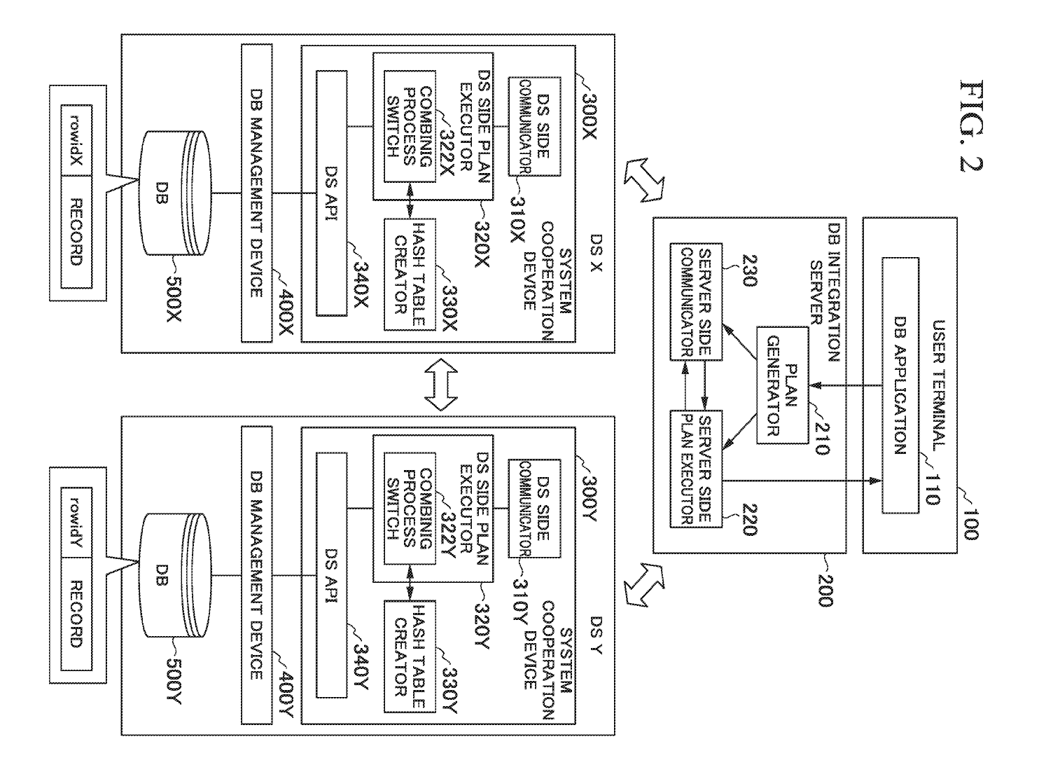

FIG. 2 is a block diagram illustrating an example of the functional configuration of the user terminal 100, the DB integration server 200, the DS X, and the DS Y. The user terminal 100 is a computer in which a DB application 110 is installed. The user terminal 100 is an example of a client of the DB integration server 200. The DB application 110 generates a query described in a structured query language (SQL) on the basis of, for example, a user's operation. In the embodiment, the DB application 110 generates a query for requesting a result of combining data stored in the DS X and data stored in the DS Y The DB application 110 transmits the generated query to the DB integration server 200 using a network interface card (MC). Also, the DB application 110 receives a response to the query from the DB integration server 200.

The DB integration server 200 includes, for example, a plan generator 210, a server side plan executor 220, and a server side communicator 230. These functional units are realized by a processor such as a central processing unit (CPU) executing a program stored in a program memory. Also, some or all of these functional units may be realized by hardware such as large scale integration (LSI), an application specific integrated circuit (ASIC), or a field-programmable gate array (FPGA) or may be realized by cooperation of software and hardware.

The plan generator 210 receives the query received from the DB application 110. The plan generator 210 interprets the received query and generates an execution plan.

The execution plan represents a procedure of extracting data specified in the query from the DS X and the DS Y and combining data on the basis of a result of collating hash values of the extracted data.

Using the server side communicator 230, the server side plan executor 220 transmits an inquiry to the DS X and the DS Y based on the execution plan generated by the plan generator 210. The DSs to which the inquiry is transmitted are a plurality of DSs X and Y that are some or all of a plurality of DSs. For example, the server side plan executor 220 transmits a request for combining the data specified in the query to each DS. Using the server side communicator 230, the server side plan executor 220 receives information including data from the DS X and the DS Y as a result of transmitting the inquiry. The server side plan executor 220 combines the data on the basis of the received information and generates a final result. The server side plan executor 220 transmits the final result to the user terminal 100 using the server side communicator 230.

The server side communicator 230 is a communication interface such as an NIC or a wireless communication module.

The system cooperation device 300X includes, for example, a DS side communicator 310X, a DS side plan executor 320X, a hash table creator 330X, and a DS application programming interface (API) 400X. These functional units are realized by a processor such as a CPU executing a program stored in a program memory. Also, some or all of these functional units may be realized by hardware such as LSI, an ASIC, or an FPGA or may be realized by cooperation of software and hardware.

The DS side communicator 310X is a communication interface such as an NIC or a wireless communication module.

The DS side plan executor 320X performs a combining process on the basis of the execution plan generated by the DB integration server 200. In the combining process, the DS side plan executor 320X extracts data from the DB 500X and collates a hash value of the extracted data with a hash value received from the DS Y. The DS side plan executor 320X transmits information based on a collation result to the DB integration server 200 using the DS side communicator 310X.

The DS side plan executor 320X includes a combining process switch 322X. The combining process switch 322X determines whether a process of collating the hash values is performed in the DS X or the DS Y.

The hash table creator 330X converts data extracted by the DS side plan executor 320X into a hash value according to a predetermined hash function. The hash table creator 330X creates a hash table in which the hash value is associated with identification information associated with data.

The DS API 340X exchanges data and commands between the DS side plan executor 320X and an application program in the DB management device 400X. The DS API 340X causes the DB management device 400X to extract data from the DB 500X by receiving a request from the DS side plan executor 320X.

The DB management device 400X is realized, for example, by a processor such as a CPU executing a DBMS stored in a program memory. Also, some or all of these functional units may be realized by hardware such as LSI, an ASIC, or an FPGA or may be realized by cooperation of software and hardware. The DB management device 400X operates the DB 500X on the basis of a query received from an external device. Also, the DB management device 400X extracts data from the DB 500X on the basis of a request received from the DS API 340X and returns the extracted data to the DS API 340X.

The DB 500X stores a table. The table is information in which records are associated with rowidX as identification information added to each row rowidX is information for uniquely specifying a record stored in the DS X. The record has data associated with one or more columns. Thereby, each piece of data is associated with one rowidX.

The system cooperation device 300Y includes, for example, a DS side communicator 310Y, a DS side plan executor 320Y, a hash table creator 330, and a DS API 400Y. These functional units are implemented, for example, by a processor such as a CPU executing a program stored in a program memory. Also, some or all of these functional units may be realized by hardware such as LSI, an ASIC, or an FPGA or may be realized by cooperation of software and hardware.

The DS side communicator 310Y is a communication interface such as an NIC or a wireless communication module.

The DS side plan executor 320Y performs a combining process on the basis of an execution plan generated by the DB integration server 200. In the combining process, the DS side plan executor 320Y extracts data from the DB 500Y and collates a hash value of the extracted data with a hash value received from the DS X. The DS side plan executor 320Y transmits information based on a collation result to the DB integration server 200 using the DS side communicator 310Y.

The DS side plan executor 320Y includes a combining process switch 322Y. The combining process switch 322Y determines whether a process of collating hash values is performed in the DS Y or the DS X.

The hash table creator 330Y converts data extracted by the DS side plan executor 320Y, into a hash value according to a predetermined hash function. The hash table creator 330Y creates a hash table in which a hash value is associated with identification information associated with data.

The DS API 340Y exchanges data and commands between the DS side plan executor 320Y and an application program in the DB management device 400Y. By receiving a request from the DS side plan executor 320Y the DS API 340Y causes the DB management device 400Y to extract data from the DB 500Y.

The DB management device 400Y is realized, for example, by a processor such as a CPU executing a DBMS stored in a program memory. Also, some or all of these functional units may be realized by hardware such as LSI, an ASIC, or an FPGA or may be realized by cooperation of software and hardware. The DB management device 400Y operates the DB 500Y on the basis of a query received from an external device. Also, the DB management device 400Y extracts data from the DB 500Y on the basis of a request received from the DS API 340Y and returns the extracted data to the DS API 340Y.

The DB 500Y stores a table. The table is information in which records are associated with rowidY as identification information added to each row. rowidY is information for uniquely specifying the record stored in the DS Y. A record has data associated with one or more columns. Thereby, each piece of data is associated with one rowidY.

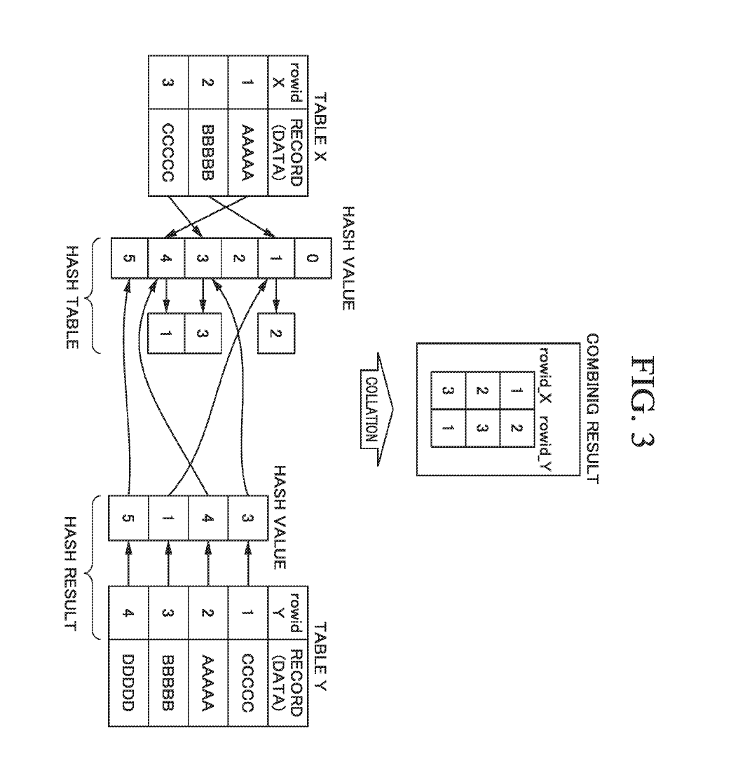

Hereinafter, an outline of the combining process performed in the DS X and the DS Y will be described. FIG. 3 is a diagram illustrating the outline of the combining process in the embodiment. It is assumed that the following SELECT statement has been received by the DB integration server 200.

SELECT*FROM X, Y WHERE x1=y1

“*” following a SELECT clause in the SELECT statement is information for specifying data to be combined, “X, Y” after a FROM clause is information for specifying a DB from which the data to be combined is extracted, and “x1=y1” following a WHERE clause is information for specifying a condition that data to be combined. That is, this SELECT statement is a query that requests combining data satisfying a condition that values of columns in a table X and a table Y be equal.

The DS side plan executor 320X extracts the table X from the DB 500X. The table X has one piece of data in a record associated with each of rowidX “1,” “2,” and “3.” The hash table creator 330X generates a hash value based on data included in the table X. For example, the hash table creator 330X converts data “AAAAA” into a hash value “4,” converts data “BBBBB” into a hash value “1,” and converts data “CCCCC” into a hash value “3.” The hash table creator 330X creates a hash table representing an array with a hash value as a subscript.

On the other hand, the DS side plan executor 320Y extracts the table Y from the DB 500Y. The table Y includes one piece of data in a record associated with each of rowidY “1,” “2,” “3,” and “4.” The hash table creator 330Y generates a hash value based on data included in the table Y. For example, the hash table creator 330Y converts data “CCCCC” into a hash value “3,” converts data “AAAAA” into a hash value “4,” converts data “BBBBB” into a hash value “1,” and converts data “DDDDD” into a hash value “5.” The hash table creator 330Y creates a hash result in which rowidX “1” is associated with the hash value “3,” the hash value “4” is associated with rowidX “2,” the hash value “1” is associated with rowidX “3,” and the hash value “5” is associated with rowidX “4.”

Either the DS X or the DS Y collates the hash value included in the hash result with the hash value included in the hash table. Either the DS X or the DS Y creates a combining result including a pair of rowidX and rowidY corresponding to the matching hash value. In other words, either the DS X or the DS Y creates a pair of rowidX and rowidY corresponding to data based on the matching hash value.

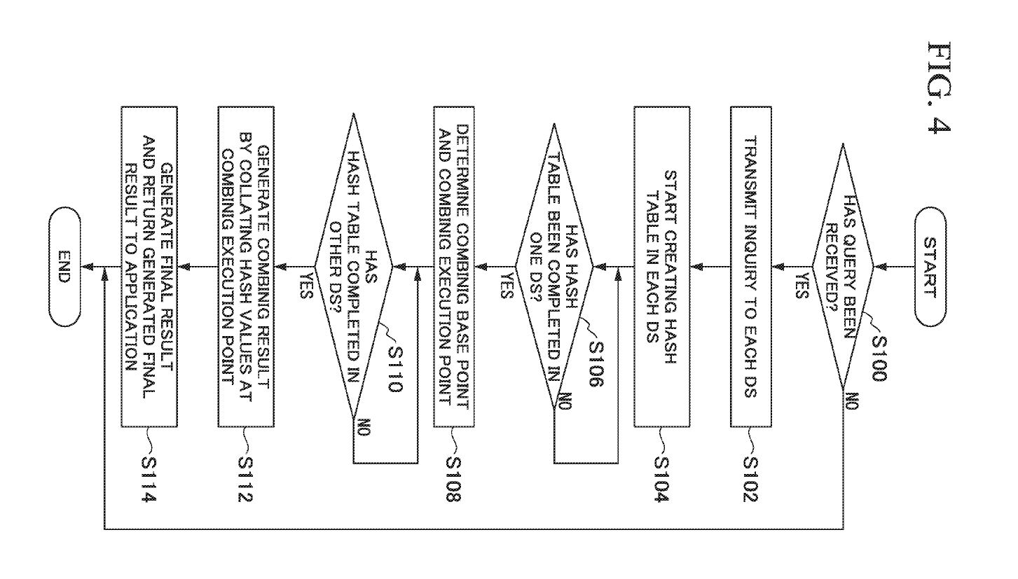

Hereinafter, the overall process of combining data in the DS 1 of the embodiment will be described. FIG. 4 is a flowchart illustrating an example of the overall processing flow for combining data in the DS 1 of the embodiment.

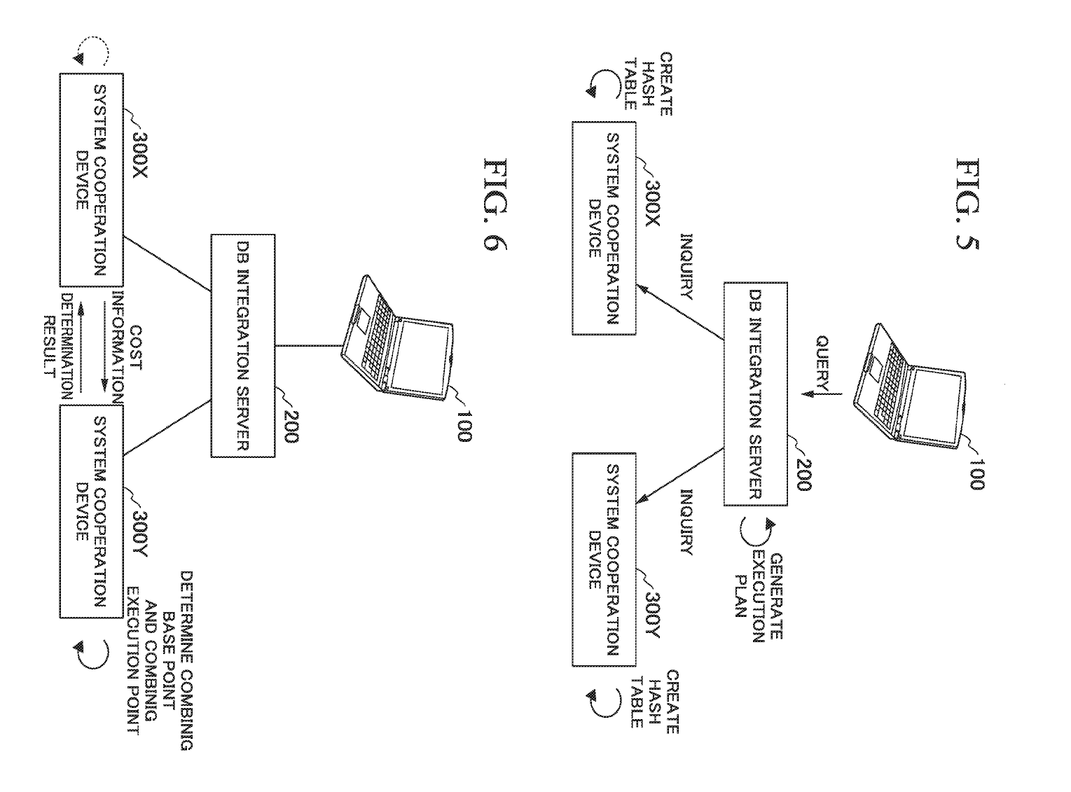

First, the DB integration server 200 determines whether or not the query transmitted by the user terminal 100 has been received (step S100). Also, this determination process is repeatedly executed every predetermined time in the DB integration server 200, for example. If the query has been received, the DB integration server 200 transmits an inquiry to the DS X and the DS Y (step S102). Next, each of the DS X and the DS Y starts creating a hash table (step S104). FIG. 5 is a diagram illustrating an outline of a process of generating a hash table. The DB integration server 200 transmits an inquiry based on the query to the system cooperation device 300X and the system cooperation device 300Y at substantially the same time or with a time difference between processes of transmitting two inquiries. Thereby, the DS X and the DS Y asynchronously perform processes of generating a hash value.

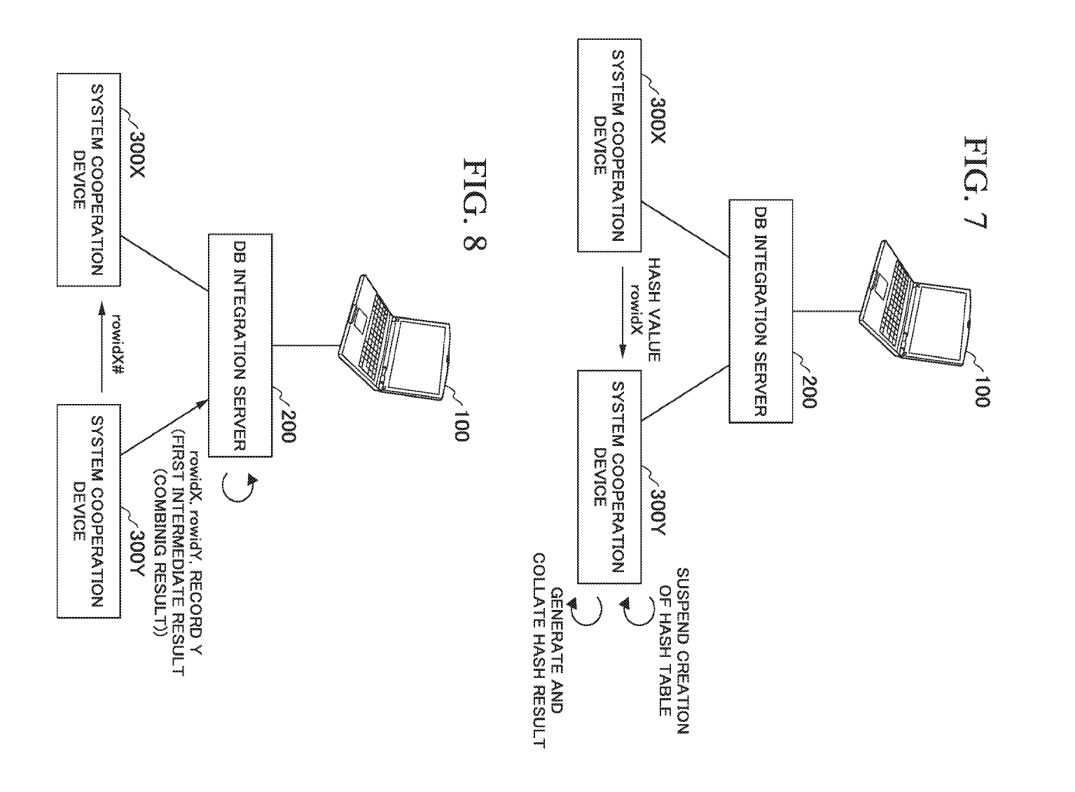

Next, the DS 1 determines whether or not the hash table has been completed in one of the DS X and the DS Y (step S106). Next, the DS 1 determines a combining base point and a combining execution point at the timing at which the hash table was completed in one of the DS X and the DS Y (step S108). FIG. 6 is a diagram illustrating an outline of a process of determining the combining base point and the combining execution point. If the creation of the hash table has been completed, the combining process switch 322X transmits cost information to the system cooperation device 300Y. The cost information is also an example of a generating completion notification for notifying that the process of generating the hash value is completed. The cost information includes at least one of a size of the hash table, a processing load in the DS X, and performance of the DS X. The combining process switch 322Y compares the cost information received from the system cooperation device 300X with its own state corresponding to the cost information, thereby determining the combining base point and the combining execution point.

The DS (first DS) of the combining base point is a DS that functions as a transmission side device that transmits the hash table to a partner side DS of the DS X and the DS Y. The DS (second DS) of the combining execution point is a DS that functions as a collation side device which generates a collation result by collating a hash value in a hash result transmitted by a partner side DS of the DS X and the DS Y with a hash value in its own created hash table.

When the size of the hash table has been received as the cost information, the combining process switch 322Y determines the DS X as the combining execution point and determines the DS Y as the combining base point if the received size of the hash table is larger than a size of a hash table created by the hash table creator 330Y. If the received size of the hash table is smaller than or equal to the size of the hash table created by the hash table creator 330Y, the combining process switch 322Y determines the DS Y as the combining execution point, and determines the DS X as the combining base point. The size of the hash table is, for example, the number of rows.

When the processing load has been received as the cost information, the combining process switch 322Y determines the DS X as the combining execution point and determines the DS Y as the combining base point if the received processing load is higher than a processing load of the DS Y. If the received processing load is equal to or lower than the processing load of the DS Y, the combining process switch 322Y determines the DS Y as the combining execution point and determines the DS X as the combining base point. The processing load is, for example, a usage rate of the CPU.

When the processing load has been received as the cost information, the combining process switch 322Y determines the DS X as the combining execution point and determines the DS Y as the combining base point if the received performance is higher than the performance of the DS Y. If the received performance is equal to or lower than the performance of the DS Y, the combining process switch 322Y determines the DS Y as the combining execution point and determines the DS X as the combining base point.

When the size of the hash table, the processing load in the DS X, and the performance of the DS X have been received as the cost information, the combining process switch 322Y determines the combining base point and the combining execution point on the basis of a communication load or a CPU load if the size of the hash table is small and calculation capability based on the processing load and the performance is low or if the size of the hash table is large and calculation capability based on the processing load and the performance is high. If the communication load is regarded as important, the combining process switch 322Y determines one DS having the smaller hash table size as the combining base point and determines the other DS as the combining execution point. If the CPU load is regarded as important, the combining process switch 322Y determines one DS having the higher calculation capability as the combining execution point and determines the other DS as the combining base point. Also, the combining process switch 322Y may determine one DS having the smaller hash table size and the higher calculation capability as the combining base point and determine the other DS as the combining execution point. Further, the combining process switch 322Y may determine one DS having the larger hash table size and the lower computing capability as the combining execution point and determine the other DS as the combining base point.

Further, the combining process switch 322Y may determine the combining base point and the combining execution point based on a preset rule. The combining process switch 322Y may determine one DS that first completed the hash table as the combining execution point and determine the other DS as the combining base point. In this case, the hash table creator 330X and the hash table creator 330Y provide notifications to the partner DS at the timing at which the hash table was completed. Thereby, the combining process switch 322Y can determine the combining base point and the combining execution point by assuming that the calculation capability of the DS that first completed the hash table is high. Also, the combining process switch 322Y may determine one DS that first completed the hash table as the combining base point and determine the other DS as the combining execution point. Thereby, the combining process switch 322Y can determine the combining base point and the combining execution point by assuming that the size of the hash table in the DS that first completed the hash table is small.

The DS side plan executor 320Y transmits the determination result of the combining process switch 322Y to the DS X. The combining process switch 322X switches the DS X to the combining base point or the combining execution point on the basis of the determination result of the combining process switch 322Y.

Next, the DS 1 determines whether or not the hash table has been completed in the other of the DS X and the DS Y (step S110). Next, the DS 1 generates a combining result by collating hash values with each other in the DS of the combining execution point at a timing at which the hash table was completed in the other of the DS X and the DS Y (step S112).

Next, the DB integration server 200 generates a final result on the basis of the combining result and returns the generated final result to the DB application 110 (step S114).

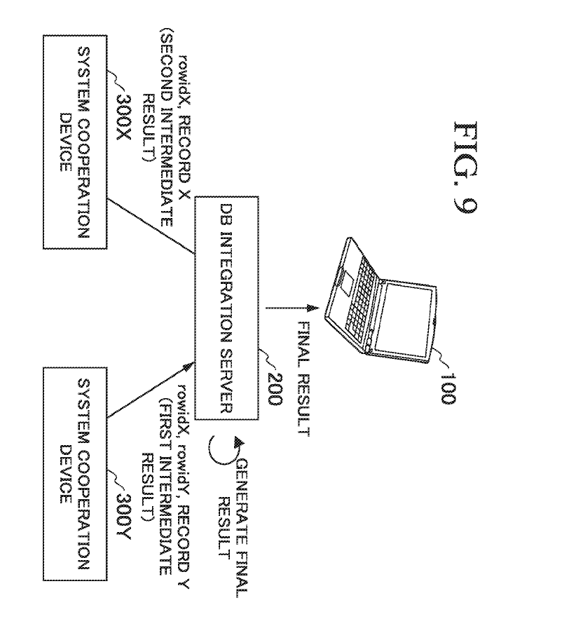

FIG. 7 is a diagram illustrating an outline of a process of collating hash values when the DS X is determined to be a combining base point and the DS Y is determined to be a combining execution point. The system cooperation device 300X transmits a hash table including rowidX and a hash value to the system cooperation device 300Y. If the hash table has been received, the system cooperation device 300Y suspends a hash table creation process in the hash table creator 330Y. Next, the system cooperation device 300Y generates a hash table and collates a hash value in the generated hash table with a hash value in a received hash result. Also, the system cooperation device 300Y can use the hash table being created as it is as the hash result without recalculating the hash table.

FIG. 8 is a diagram illustrating an outline of a process of transmitting a combining result when the DS X is determined to be a combining base point and the DS Y is determined to be a combining execution point. On the basis of a collation result, the system cooperation device 300Y transmits a pair of rowidX and rowidY associated with a matching hash value (a combining result) and a record Y of rowidY to the DB integration server 200 as a first intermediate result. Also, the system cooperation device 300Y transmits rowidX# associated with the matching hash value among received rowidX to the DS X.

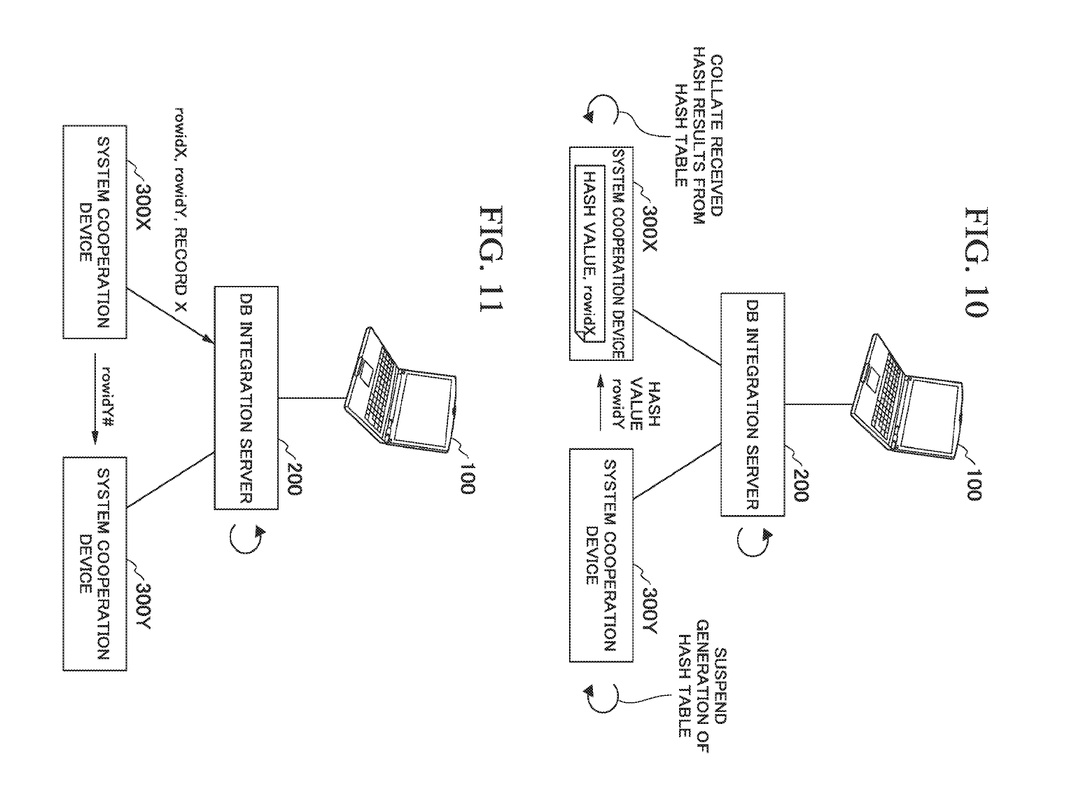

FIG. 9 is a diagram illustrating an outline of a process of generating a final result when the DS X is determined to be a combining base point and the DS Y is determined to be a combining execution point. If rowidX# has been received, the system cooperation device 300X transmits rowidX and a record X corresponding to rowidX# to the DB integration server 200 as a second intermediate result. The server side plan executor 220 compares the record Y included in the first intermediate result with the record X included in the second intermediate result on the basis of a combining result. The server side plan executor 220 generates a final result on the basis of a comparison result. The server side plan executor 220 transmits the generated final result to the DB application 110.

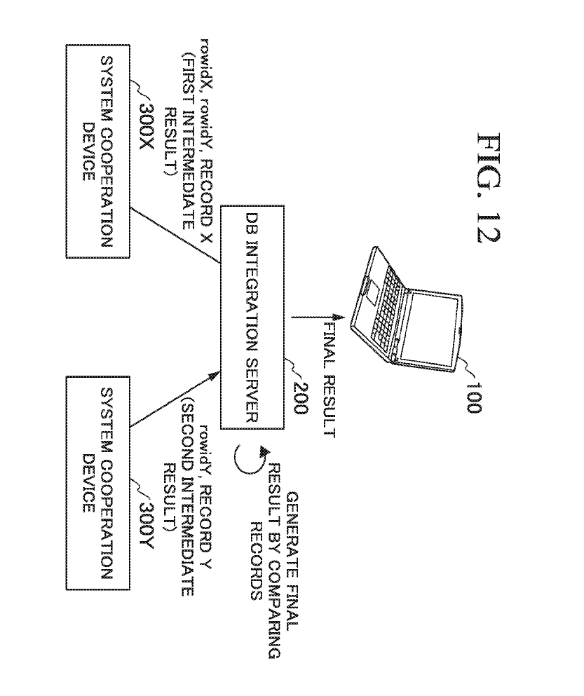

FIG. 10 is a diagram illustrating an outline of a process of collating a hash value when the DS X is determined to be a combining execution point and the DS Y is determined to be a combining base point. The system cooperation device 300Y suspends creation of a hash table and transmits information including a hash value obtained through generating and rowidY to the system cooperation device 300X. Also, whenever the hash value is generated, the system cooperation device 300Y transmits the hash value and rowidY to the system cooperation device 300X. The system cooperation device 300Y can use the hash table being created as it is as a hash result without recalculating the hash table. The system cooperation device 300Y may process the creation of the hash table and the transmission of the information in parallel without suspending the creation of the hash table. Also, the system cooperation device 300Y may transmit hash values together without transmitting the hash value each time.

If the hash value and rowidY have been received, the system cooperation device 300X generates a combining result by collating the hash value in the already created hash table with the received hash value. Also, every time the hash value and rowidY are received from the system cooperation device 300Y, the system cooperation device 300X adds a pair of rowid of the matching hash value to the combining result.

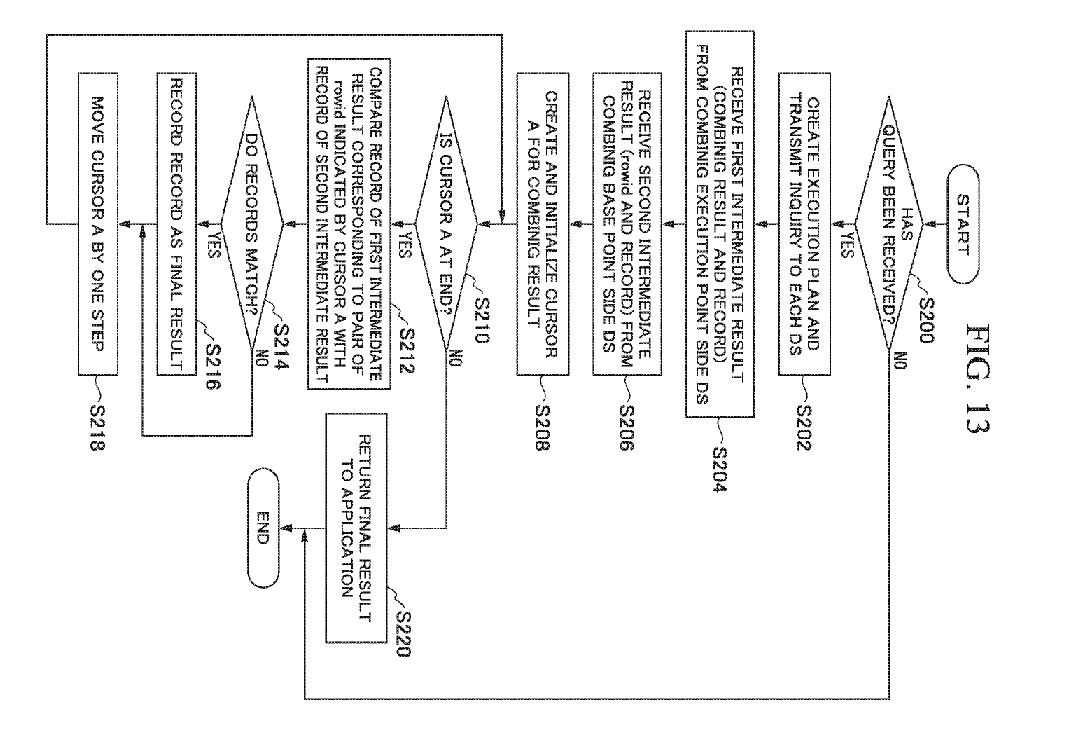

FIG. 11 is a diagram illustrating an outline of a process of transmitting a combining result when the DS X is determined to be a combining execution point and the DS Y is determined to be a combining base point. On the basis of a collation result, the system cooperation device 300X transmits a pair of rowidX and rowidY associated with a matching hash value (a combining result) and a record X of rowidX to the DB integration server 200 as a first intermediate result. Also, the system cooperation device 300X transmits rowid Y# associated with the matching hash value to the DS Y among received rowidY.

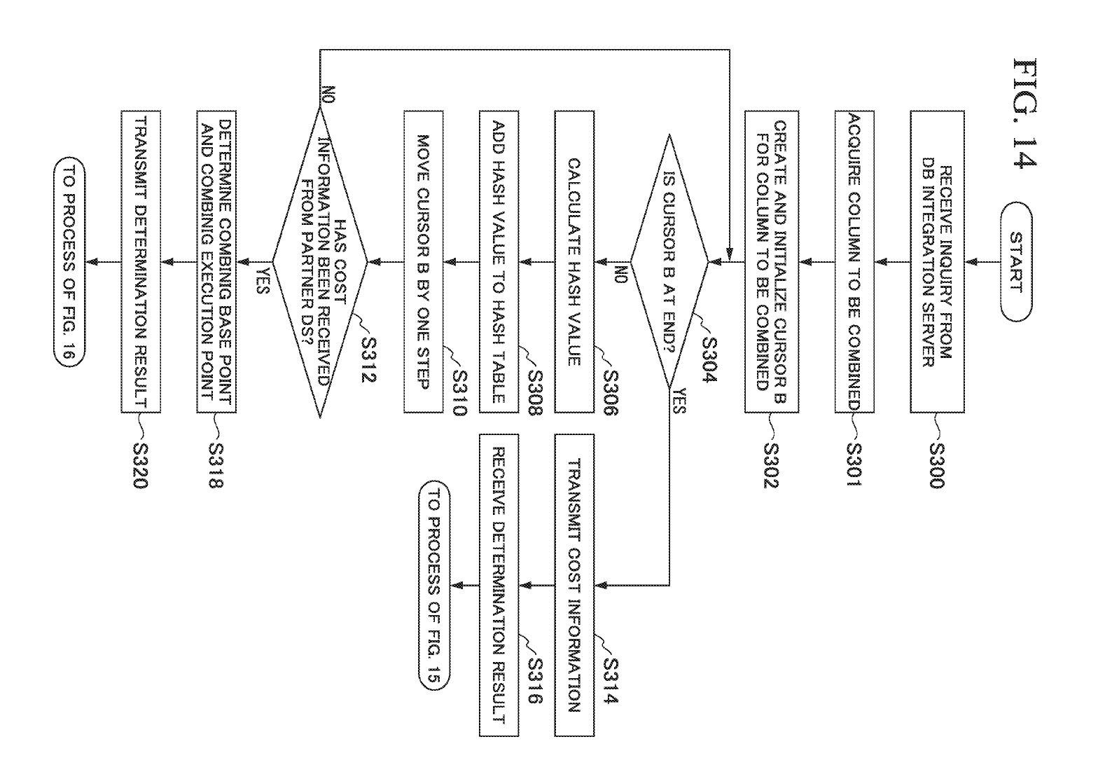

FIG. 12 is a diagram illustrating an outline of a process of generating a final result when the DS X is determined to be a combining execution point and the DS Y is determined to be a combining base point. If rowidY# has been received, the system cooperation device 300Y transmits rowidY and a record Y corresponding to the rowidY# to the DB integration server 200 as a second intermediate result. On the basis of a combining result, the server side plan executor 220 compares the record X included in the first intermediate result with the record Y included in the second intermediate result. The server side plan executor 220 generates a final result on the basis of a comparison result. The server side plan executor 220 transmits the generated final result to the DB application 110.

Hereinafter, internal processing in the DB integration server 200 and the DS will be described. FIG. 13 is a flowchart illustrating an example of a flow of internal processing in the DB integration server 200 according to the embodiment. The process of the flowchart illustrated in FIG. 13 is repeatedly executed every predetermined time in the DB integration server 200, for example.

First, the DB integration server 200 determines whether or not a query has been received from the user terminal 100 (step S200). If the query has been received, the DB integration server 200 creates an execution plan and transmits an inquiry to each DS (step S202). If the query has not been received, the DB integration server 200 terminates the process of this flowchart.

Next, the DB integration server 200 receives the first intermediate result from the DS of the combining execution point (step S204). Next, the DB integration server 200 receives the second intermediate result from the DS of the combining base point (step S206). Next, the DB integration server 200 creates a cursor A for specifying any row in the combining result and initializes the cursor A (step S208). Each row in the combining result has one pair of rowid. By initializing the cursor A, the cursor A indicates a first row of the combining result.

Next, the DB integration server 200 determines whether or not the cursor A is at the end (step S210). If the cursor A is not at the end, the DB integration server 200 compares a record of the first intermediate result corresponding to the pair of rowid indicated by the cursor A with a record of the second intermediate result (step S212), and determines whether or not the records match (step S214). If the record of the first intermediate result matches the record of the second intermediate result, the DB integration server 200 records a pair of the record of the first intermediate result and the record of the second intermediate result as a final result (step S216). Next, the DB integration server 200 moves the cursor A by one step (step S218) and returns the process to step S210.

If the record of the first intermediate result does not match the record of the second intermediate result, the DB integration server 200 does not record the record of the first intermediate result and the record of the second intermediate result as a final result. Thereby, the DB integration server 200 prevents a record of a source from which the hash value matched by a hash collision is calculated from being included in the final result.

When the value of the cursor A is at the end, the DB integration server 200 transmits the final result to the DB application 110 (step S220).

FIG. 14 is a flowchart illustrating an example of a flow of internal processing in the system cooperation device according to the embodiment. The process of the flowchart illustrated in FIG. 14 is repeatedly executed every predetermined time in the DB integration server, for example. Also, the system cooperation device 300X and the system cooperation device 300Y in the plurality of DSs X and Y have been separately described in the above-described embodiment, but the system cooperation device 300X and the system cooperation device 300Y will be collectively described as a “system cooperation device 300” because the following description of the process of the system cooperation device 300 is the description of a common process between the system cooperation device 300X and the system cooperation device 300Y.

First, the system cooperation device 300 receives an inquiry from the DB integration server 200 (step S300) and acquires a combining target column (data) on the basis of the inquiry (step S301). At this time, the system cooperation device 300 also acquires rowid associated with the combining target column. Next, the system cooperation device 300 creates and initializes a cursor B for the acquired combining target column (step S302). The system cooperation device 300 determines whether or not the cursor B is at the end (step S304).

If the cursor B is not at the end, the system cooperation device 300 calculates a hash value from data indicated by the cursor B (step S306) and adds the hash value to the hash table (step S308). Next, the system cooperation device 300 moves the cursor B by one step (step S310). Next, the system cooperation device 300 determines whether or not cost information has been received from the partner DS (step S312).

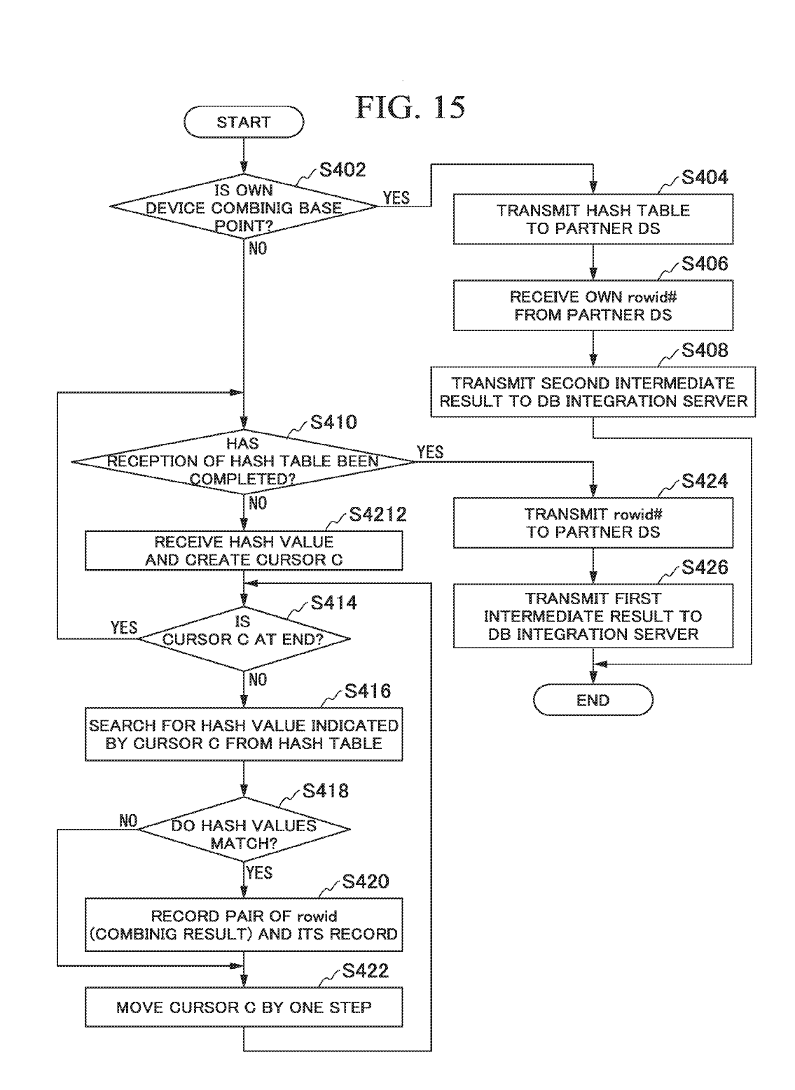

When the cost information has not been received from the other DS, the system cooperation device 300 returns the process to step S304. If the cursor B is at the end, the system cooperation device 300 transmits the cost information to the partner DS (step S314). Thereafter, the system cooperation device 300 receives a determination result transmitted by the partner DS (step S316). Thereafter, the system cooperation device 300 moves to the process of the flowchart illustrated in FIG. 15.

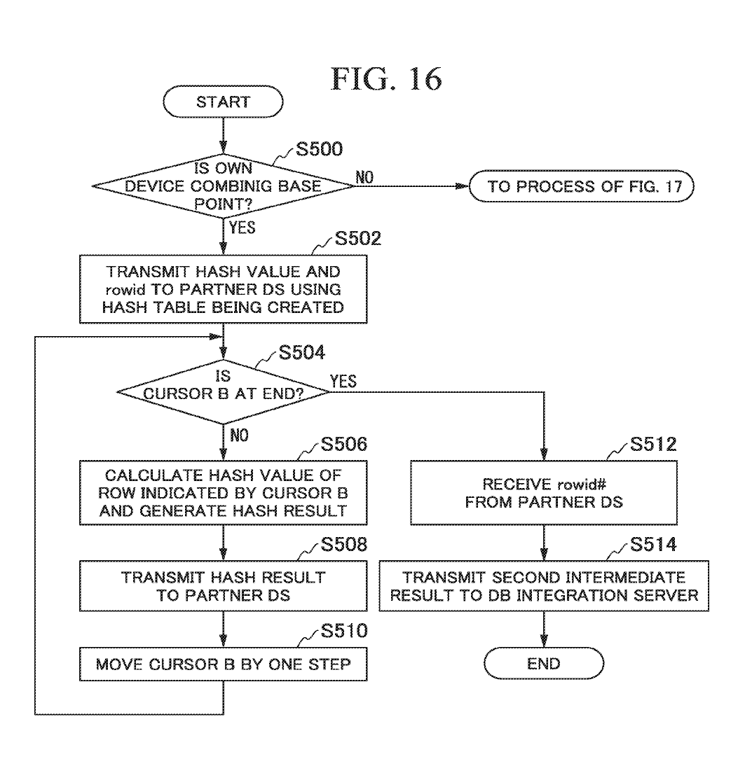

If the cost information has been received from the other DS, the system cooperation device 300 determines a combining base point and a combining execution point (step S318), and transmits a determination result to the other DS (step S320). Thereafter, the system cooperation device 300 moves to the process of the flowchart illustrated in FIG. 16.

FIG. 15 is a flowchart illustrating an example of a processing flow of the system cooperation device 300 in the DS completing the creation of the hash table earlier than the partner DS. First, the system cooperation device 300 determines whether or not the system cooperation device 300 itself is a combining base point on the basis of a received determination result (step S402). If the system cooperation device 300 itself is the combining base point, the system cooperation device 300 transmits a hash table to the partner DS (step S404). Thereafter, the system cooperation device 300 receives its own rowid# from the partner DS (step S406). rowid# is rowid corresponding to data coincident with data stored in the DB in the partner DS among data stored in its own DB. Next, the system cooperation device 300 creates a second intermediate result by extracting a record on the basis of rowid# and transmits the second intermediate result to the DB integration server 200 (step S408).

If the system cooperation device 300 itself is a combining execution point, the system cooperation device 300 determines whether or not the reception of the hash table has been completed (step S410). If the reception of the hash table has not been completed, the system cooperation device 300 receives the hash table transmitted by the other DS every time and creates a cursor C for the received hash table (step S412). Next, the system cooperation device 300 determines whether or not the cursor C is at the end (step S414).

If the cursor C is at the end, the system cooperation device 300 returns the process to step S410. If the cursor C is not at the end, the system cooperation device 300 searches for the hash value indicated by the cursor C from the hash table created by its own hash table creator (step S416). The system cooperation device 300 determines whether or not hash values match (step S418). If the hash values match, the system cooperation device 300 records a pair of rowid and a record corresponding to its own rowid in a storage unit (not illustrated) (step S420). Next, the system cooperation device 300 moves the cursor C by one step (step S422) and returns the process to step S414.

When the reception of the hash table has been completed, the system cooperation device 300 transmits rowid# of the partner DS corresponding to the matching hash value to the partner DS (step S424). Next, the system cooperation device 300 transmits a pair of rowid of the matching hash value (a combining result) and a first intermediate result including its own record to the DB integration server 200 (step S426). Thereby, the process of the system cooperation device 300 in the DS that first completed the creation of the hash table is terminated.

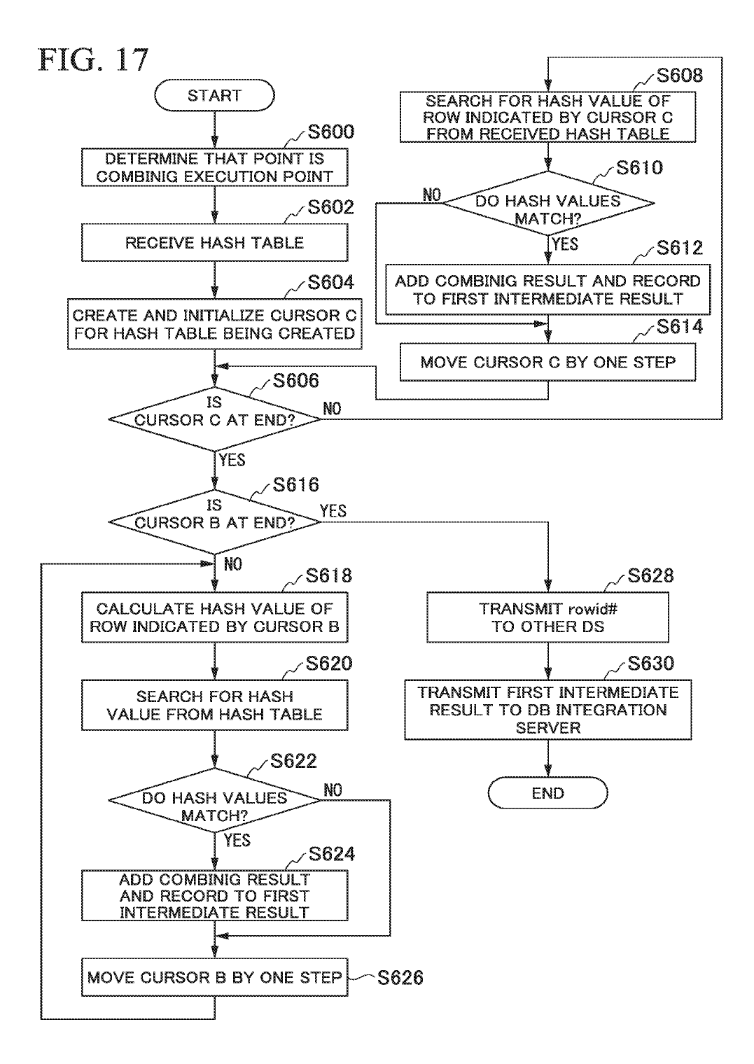

FIG. 16 is a flowchart illustrating an example of a processing flow of the system cooperation device 300 in a DS that has received cost information from a partner DS. First, the system cooperation device 300 determines whether or not the system cooperation device 300 itself is a combining base point on the basis of the above-described determination result (step S500). If the system cooperation device 300 itself is not the combining base point, the system cooperation device 300 moves to the process of FIG. 17. If the system cooperation device 300 itself is the combining base point, the system cooperation device 300 transmits a hash value and rowid to the partner DS using a hash table being created (step S502).

Next, the system cooperation device 300 determines whether or not the cursor B for the combining target column is at the end (step S504). If the cursor B is not at the end, the system cooperation device 300 calculates a hash value of a row indicated by the cursor B and generates a hash result (step S506). Next, the system cooperation device 300 transmits the generated hash result to the partner DS (step S508), moves the cursor B by one step (step S510), and returns the process to step S504.

When the cursor B is at the end, the system cooperation device 300 receives rowid# from the partner DS (step S512), and transmits a second intermediate result to the DB integration server 200 (step S514). Thereby, the process of the system cooperation device 300 in the DS of the combining base point that has received the cost information from the partner DS is completed.

FIG. 17 is a flowchart illustrating another example of the flow of the processing of the system cooperation device 300 in the DS that has received the cost information from the partner DS. The system cooperation device 300 determines that the system cooperation device 300 itself is the combining execution point according to a determination result (step S600), and receives a hash table from the partner DS (step S602). Next, the system cooperation device 300 creates a cursor C for the hash table being created and initializes the cursor C (step S604).

Next, the system cooperation device 300 determines whether or not the cursor C is at the end (step S606). If the cursor C is not at the end, the system cooperation device 300 searches a received hash table for a hash value of a row indicated by the cursor C (step S608). The system cooperation device 300 determines whether or not hash values match (step S610). If the hash values match, the system cooperation device 300 adds a combining result (a pair of rowid) and a record corresponding to its own rowid to a first intermediate result. (step S612). Next, the system cooperation device 300 moves the cursor C by one step (step S614) and returns the process to step S606. Thereby, the system cooperation device 300 performs a process of combining hash values with respect to rows for which hash values have already been calculated.

When the cursor C is at the end, the system cooperation device 300 determines whether or not the cursor B is at the end (step S616). If the cursor B is not at the end, the system cooperation device 300 calculates a hash value of a row indicated by the cursor B (step S618), and searches for the calculated hash value from the received hash table (step S620). Next, the system cooperation device 300 determines whether or not hash values match (step S622). If the hash values match, the system cooperation device 300 adds a combining result (a pair of rowid) and a record corresponding to its own rowid to a first intermediate result (step S624). Next, the system cooperation device 300 moves the cursor B by one step (step S626) and returns the process to step S616. Thereby, the system cooperation device 300 performs a process of combining hash values with respect to a row whose hash value has not been calculated yet.

When the cursor B is at the end, the system cooperation device 300 transmits rowid# of the partner DS corresponding to a matching hash value to the other DS (step S628). Next, the system cooperation device 300 transmits the first intermediate result having the pair of rowid of the matching hash value (a combining result) and its own record to the DB integration server 200 (step S630). Thereby, the process of the system cooperation device 300 in the DS of the combining execution point that has received the cost information from the other DS is completed.

Examples will be described below. The DB integration server 200 is assumed to have received a query of the following SELECT statement.

SELECT VALUE_X, VALUE_Y FROM X, Y WHERE X.data ID=Y.dataID

This SELECT statement is information for requesting a result of combining a value X and a value Y satisfying a condition that a data ID stored in the table X included in the DB 500X be the same as a data ID stored in the table Y included in the DB 500Y. For example, the data ID is a name, the value X is a company address, and the value Y is a home address.

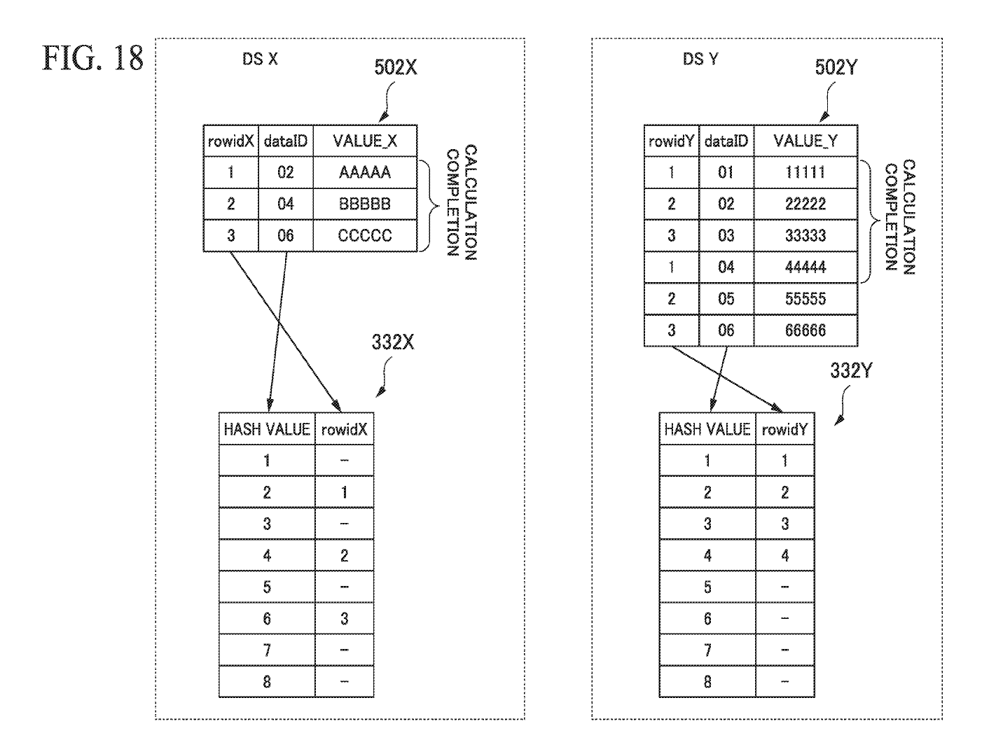

FIG. 18 is a diagram illustrating an embodiment of a process of generating a hash value from data obtained by extracting data from a DB. The DB integration server 200 causes the DS X and the DS Y to start calculating a hash value by transmitting an inquiry based on a query to the DS X and the DS Y. As illustrated in the left diagram of FIG. 18, the DS X extracts a table 502X from the DB 500X in response to the inquiry based on the query received by the DB integration server 200. The DS X calculates hash values for three rows from the data ID, and creates a hash table 332X in which rowidX is associated with the calculated hash values. Likewise, the DS Y extracts a table 502Y from the DB 500Y in response to the inquiry based on the query received by the DB integration server 200 as illustrated in the right diagram of FIG. 18. The DS Y calculates hash values for four rows from the data ID, and creates a hash table 332Y in which rowidY is associated with the calculated hash values.

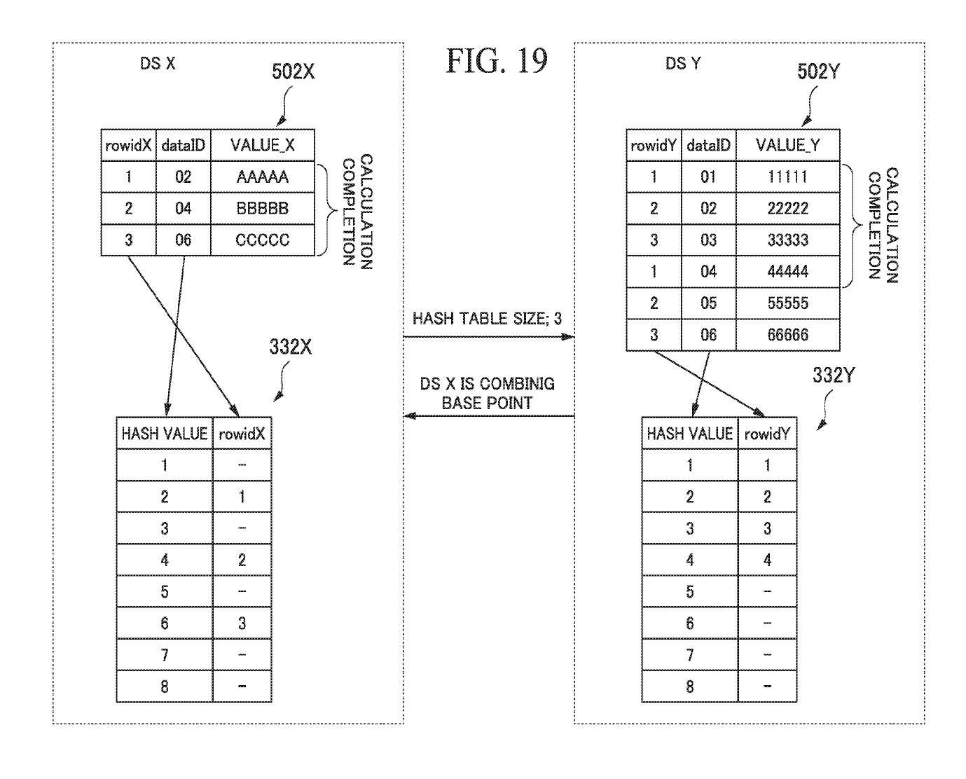

FIG. 19 is a diagram illustrating an example of a process of determining a combining base point and a combining execution point. The DS X completes the calculation of hash values for the table X by calculating hash values for three rows and transmits cost information indicating a size of a hash table of the “three rows” to the DS Y. The DS Y determines the DS X having a small hash table size as the combining base point and the DS Y as the combining execution point because the number of rows calculated at a point in time at which the cost information was received is 4. The DS Y transmits information indicating that the “DS X is the combining base point” as a determination result to the DS X.

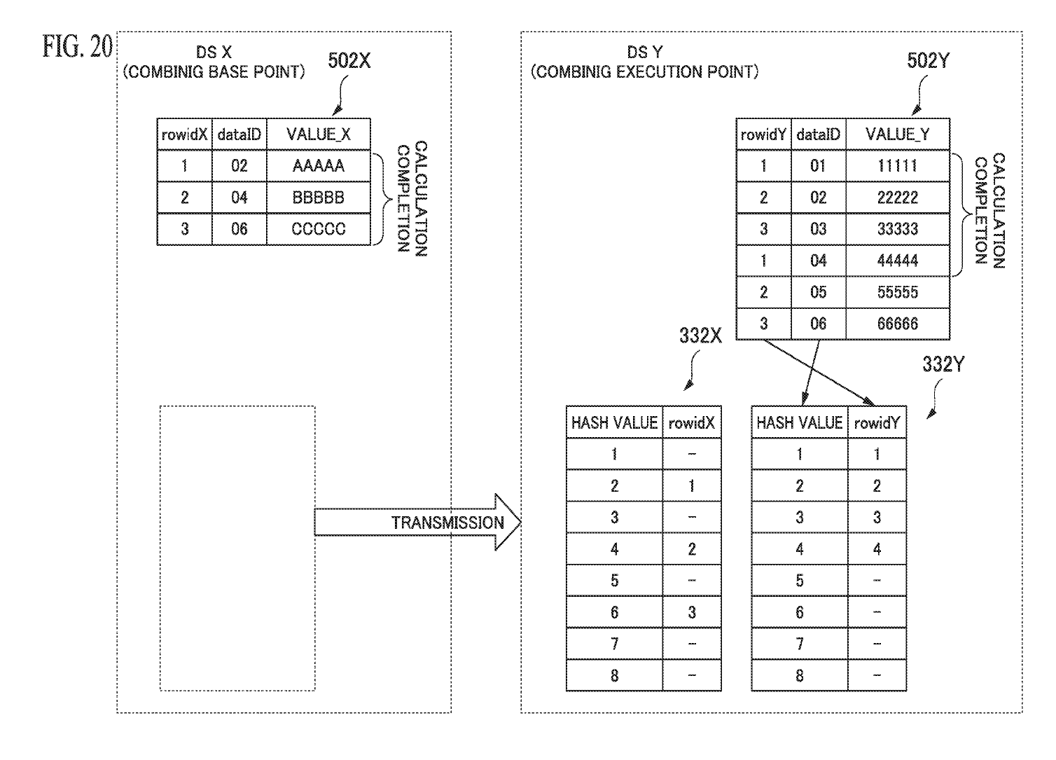

FIG. 20 is a diagram illustrating an example of a process of determining a combining base point and a combining execution point. The DS X transmits the hash table 332X to the DS Y according to reception of the determination result.

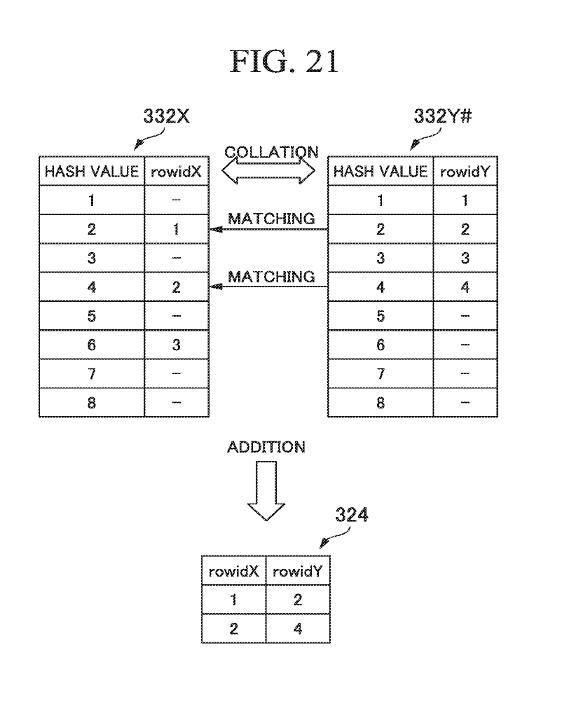

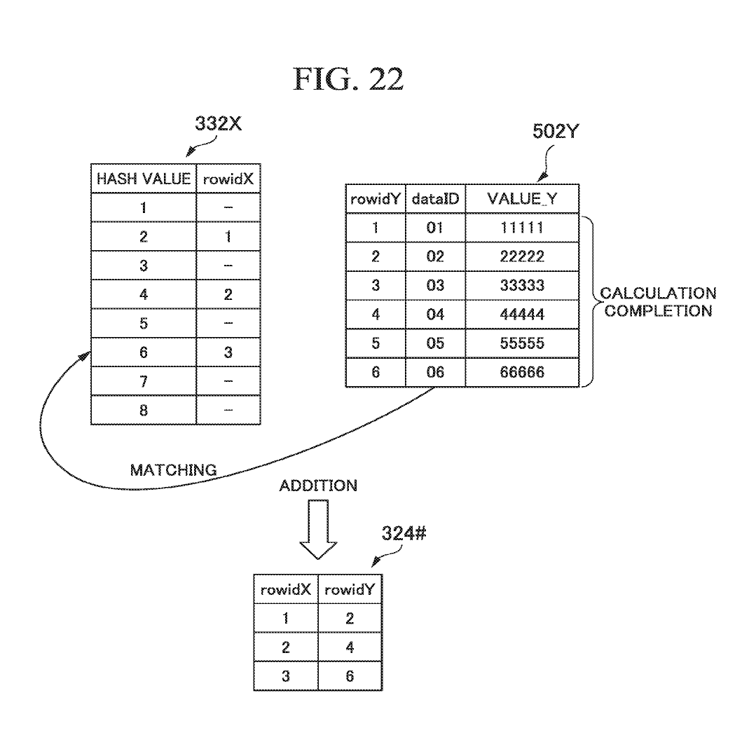

FIG. 21 and FIG. 22 are diagrams illustrating examples of a process of collating hash values. The DS Y starts collating hash values while regarding a hash table 332Y being created as a hash result 332Y#. As illustrated in FIG. 21, the DS Y collates a hash value included in the hash table 332X with a hash value included in the hash result 332Y#, and adds a pair of rowidX and rowidY associated with a matching hash value to the combining result 324. As illustrated in FIG. 22, the DS Y calculates a hash value from a data ID for which a hash value has not been calculated, and determines whether or not the calculated hash value matches a hash value included in the hash table 332X. The DS Y determines that a hash value of a data ID of “06” matches a hash value of “6” of the hash table 332X and adds a pair of rowidX “3” and rowidY “6” to a combining result 324#.

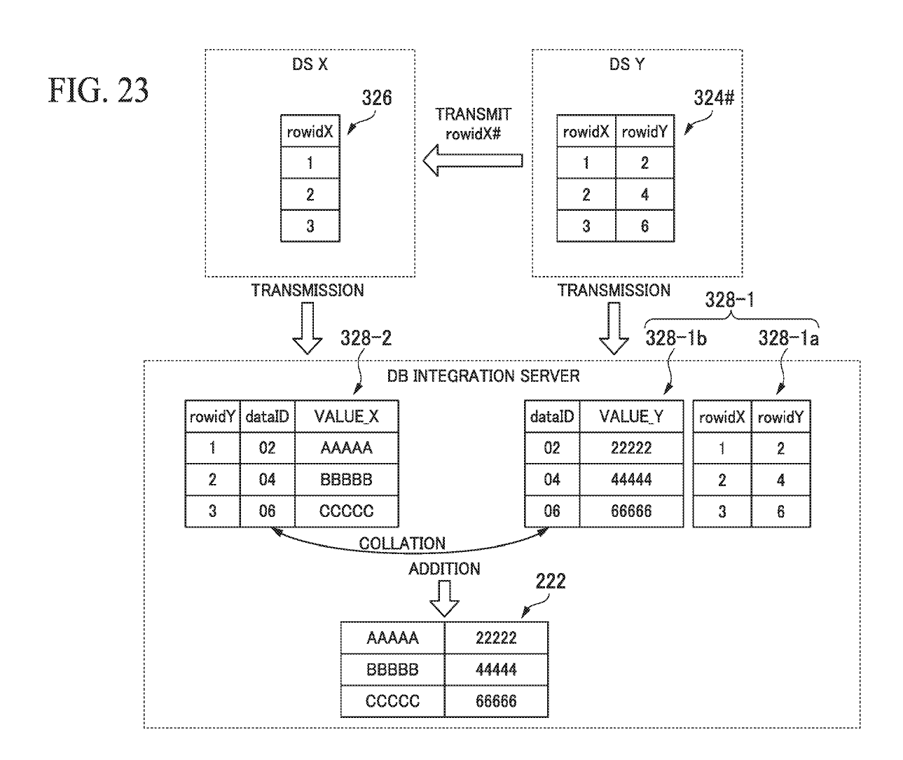

FIG. 23 is a diagram illustrating an example of a process of generating an intermediate result and a final result. According to the completion of creation of a combining result 324#, the DS Y transmits a first intermediate result 328-1 including a combining result 328-1a and a record 328-1b to the DB integration server 200. Also, the DS Y transmits rowidX# to the DS X. The DS X receives information 326 of a received series of rowidX. According to the reception of rowidX#, the DS X transmits a second intermediate result 328-2 including rowidX and a record corresponding to rowidX# to the DB integration server 200.

The DB integration server 200 refers to the combining result 328-1a, extracts data IDs corresponding to a pair of rowidX and rowidY from the record 328-1b and the second intermediate result 328-2, and collates the extracted data IDs. If the data IDs match, the DB integration server 200 adds a value X and a value Y corresponding to the data IDs as a pair to a final result 222. The DB integration server 200 transmits the final result 222 to the DB application 110 according to collation of all pairs included in the combining result 328-1a.

When a query has been received from the DB application 110, it is possible to start a process of calculating a hash value from data to be combined in a DB that has received the inquiry because the DS 1 according to the above-described embodiment transmits an inquiry from the DB integration server 200 to a plurality of DSs. That is, the plurality of data servers that have received the inquiry asynchronously perform processes of generating a hash value in parallel. Thereby, according to the DS 1, it is possible to execute a data combining process between different DSs at a higher speed.

According to the DS 1, a load of data transmission can be suppressed because it is possible to limit data transmitted from the plurality of DSs that have received the inquiry to the DB integration server 200 to data having the same hash value. Further, according to the DS 1, an amount of data transmission can be suppressed because the hash value is transmitted and received between the plurality of DSs that have received the inquiry.

According to the DS 1, the DB integration server 200 can dynamically switch a plurality of DSs that have received an inquiry between the combining base point and the combining execution point without processing by the DB integration server 200. That is, according to the DS 1, even if the DB integration server 200 does not recognize a size of a table recorded on a plurality of DSs in advance, it is possible to set the combining base point and the combining execution point.

According to the DS 1, it is possible to suppress an amount of data transmission between the DSs by switching a DS having a large hash table size to the combining execution point. Also, according to the DS 1, it is possible to complete a process of collating hash values in a shorter time by switching a DS having high calculation capability to the combining execution point. Further, according to the DS 1, it is possible to switch whether to set a DS as the combining base point or the combining execution point according to whether the communication load or the CPU load is to be emphasized. Further, according to the DS 1, it is possible to switch whether to set a DS as a combining base point or a combining execution point on the basis of a preset rule and suppress processing and time required for arbitration for determining whether it is set as the combining base point or the combining execution point.

According to at least one embodiment described above, there are provided a plurality of DSs (including X and Y); and the DB integration server 200 configured to transmit an inquiry to a plurality of DSs X and Y which are some or all of the plurality of DSs on the basis of a request for combining a plurality of pieces of data if the request has been received from the user terminal 100, wherein each of the DSs X and Y that have received the inquiry from the DB integration server 200 extracts data from the DB 500X or 500Y on the basis of the received inquiry and generates a hash value, wherein a first DS of the DSs X and Y that have received the inquiry from the DB integration server 200 transmits the hash value obtained through the generating to a second DS of the DSs X and Y that have received the inquiry from the DB integration server 200, wherein the second DS collates the hash value received from the first DS with a hash value generated by the sccond DS, transmits a collation result and data serving as a source of a matching hash value to the DB integration server 200, and transmits information corresponding to the matching hash value among hash values received from the first DS to the first DS, wherein the first DS transmits data serving as a source of a matching hash value to the DB integration server 200 on the basis of information corresponding to the matching hash value received from the second DS, and wherein the DB integration server 200 combines the data received from the first DS and the second DS on the basis of the collation result, so that it is possible to start a process of calculating hash values in the first and second DSs X and Y according to a query received from the client. Thereby, according to at least one embodiment, it is possible to execute a process of combining data between different DSs at a higher speed.

While several embodiments of the present invention have been described, these embodiments have been presented by way of example only, and are not intended to limit the scope of the invention. These embodiments may be embodied in a variety of other forms. Various omissions, substitutions and changes may be made without departing from the spirit of the invention. The invention described in the accompanying claims and its equivalents are intended to cover such embodiments or modifications as would fall within the scope and spirit of the invention.

Although combining data extracted from the DBs in the two DSs X and Y has been described in the above-described embodiment, the present invention is not limited thereto and data extracted from more than two DSs may be combined. If three or more pieces of data are combined, data extracted from two DSs is first combined, and then data extracted from the other DSs is combined.

What is claimed is:

1. A system comprising:
a plurality of database (DB) systems (DSs) comprising a first DS that configured to manage a first DB and a second DS that configured to manage a second DB; and
an integration server configured to transmit an inquiry to the first DS and the second DS based on a request for combined data from a client,
wherein the first DS in accordance of the inquiry from the integration server, extract first data from the first DB and generate a first hash value based on the first data,
wherein the second DS in accordance of the inquiry from the integration server, extract second data from the second DB and generate a second hash value based on the second data,
wherein the first DS transmits the first hash value to the second DS,
wherein the second DS collates the first hash value with the second hash value, transmits, to the integration server, a collation result and at least a part of the second data, for which the first hash value and the second hash value are matched, and transmits a matched part of hash values to the first DS,
wherein the first DS transmits at least a part of the first data that was a source of the matched part of hash values to the integration server, and
wherein the integration server combines the data received from the first DS and the second DS on the basis of the collation result.

2. The system according to claim 1, wherein the first DS and the second DS asynchronously generate the first hash value and the second hash value, respectively.

3. The system according to claim I, wherein one of the two DSs that received the inquiry from the integration server, decides whether the one performs as the first DS or the second DS, and transmit the decision to the other of the two DSs that received the inquiry from the integration server.

4. The system according to claim 3,
wherein each of the two DSs that received the inquiry from the integration server transmits a generating completion notification to one of the two DS that received the inquiry from the integration server, in case that the generating the hash value has been completed and the decision has not been received, and
wherein the DS that has received the generating completion notification determines whether to perform as the first DS or the second DS.

5. The system according to claim 4,
wherein each of the two DSs that have received the inquiry from the integration server transmits information based on an amount of data extracted on the basis of the inquiry received from the integration server to the other DS of the two DSs in a case that the process of generating the hash value has been completed, and
wherein the other DS of the two DSs compares the information based on the amount of data with information based on an amount of data extracted by the other DS and determines whether to performs as the first DS or the second DS on the basis of a comparison result.

6. The system according to claim 4,
wherein each of the two DSs that have received the inquiry from the integration server transmits information indicating capability of its own device to the other DS of the two DSs in a case that the process of generating the hash value has been completed, and
wherein the other DS of the two DSs compares the received information indicating the capability with capability of its own device and determines whether to perform as the first DS or the second DS on the basis of a comparison result.

7. The system according to claim 4,
wherein each of the two DSs that have received the inquiry from the integration server provides a notification to the other DS of the two DSs at a timing at which the process of generating the hash value was completed, and
wherein the other DS of the two DSs determines whether to perform as the first DS or the second DS on the basis of a rule for determining an execution side device and a base point side device on the basis of a timing at which the notification was received.

8. A data combining method comprising:
receiving, by an integration server, a request for combining a plurality of pieces of data from a client;
transmitting, by the integration server, an inquiry to two of a plurality of DSs on the basis of the request;
extracting, by a first DS of the two DSs, first data from a first DB on the basis of the received inquiry and generating a first hash value based on the first data;
extracting, by a second DS of the two DSs, second data from a second DB on the basis of the received inquiry and generating a second hash value based on the second data;
transmitting, by the first DS, the first hash value to the second DS;
collating, by the second DS, the first hash value received from the first DS with the second hash value, transmitting, to the integration server, a collation result and at least a part of the second data, for which the first hash value and the second hash value are matched, and transmitting a matched part of hash values to the first DS;
transmitting, by the first DS, at least a part of the first data that was a source of the matched part of hash values to the integration server; and
combining, by the integration server, the data received from the first DS and the second DS on the basis of the collation result.

9. An integration server comprising:
a communicator configured to communicate with a client and a plurality of DSs for managing DBs storing data associated with identification information; and
an executor configured to:
transmit an inquiry to two of a plurality of DSs on the basis of a request for combining a plurality of pieces of data in a case that the request has been received from the client;
collate data received from a first DS of the two DSs with data received from a second DS of the two DSs on the basis of an identification information combination and transmit a result of combining matched data to the client, in a case that the identification information combination and data associated with one piece of identification information of the identification information combination have been received from the first DS and data associated with other piece of identification information of the identification information combination has been received from the second DS.

10. The integration server according to claim 9,
wherein the executor simultaneously transmits an inquiry based on the request to two of the plurality of DSs.

11. A data combining method comprising:
receiving a request for combining a plurality of pieces of data from a client;
transmitting an inquiry to two of a plurality of DSs for managing DBs storing data associated with identification information on the basis of the request;
receiving an identification information combination and data associated with one piece of identification information of the identification information combination from a first DS of the two DSs and receiving data associated with other piece of identification information of the identification information combination from a second DS of the two DSs;
collating the data received from the first DS with the data received from the second DS on the basis of the identification information combination; and
transmitting a result of combining matched data to the client.

12. A data combining program for causing a computer to:
receive a request for combining a plurality of pieces of data from a client;
transmit an inquiry to two of a plurality of DSs for managing DBs storing data associated with identification information on the basis of the request;
receive an identification information combination and data associated with one piece of identification information of the identification information combination from a first DS of the two DSs and receive data associated with other piece of identification information of the identification information combination from a second DS of the two DSs;
collate the data received from the first DS with the data received from the second DS on the basis of the identification information combination; and
transmit a result of combining matched data to the client.

13. A DS comprising:
a DB;
a communicator configured to communicate with an integration server for combining data and another DS different from its own device;
a receiver configured to receive an inquiry based on a request for combining a plurality of pieces of data from the integration server using the communicator;
an extractor configured to extract data of the DB on the basis of the received inquiry;
a generator configured to generate a hash value based on the data extracted by the extractor;
a switch configured to switch the status of the DS between a base point side device for transmitting the hash value generated by its own device to the other DS that has received the inquiry from the integration server, and an execution side device for collating a hash value generated by the other DS that has received the inquiry from the integration server with the hash value generated by its own device, by communicating with the other DS that has received the inquiry from the integration server using the communicator; and
an executor configured to receive, in a case that the status of the DS is the execution side device, a hash value from a DS of the base point side device using the communicator, collate the hash value obtained by the generator with the received hash value, transmit a collation result and data serving as a source of a matched part of hash values to the integration server, and transmit matched part of hash values to the DS of the base point side device, and,
configured to transmit, in a case that the status of the DS is the base point side device, the hash value generated by the generator to a DS of the execution side device using the communicator and transmit the data extracted by the extractor to the integration server using the communicator on the basis of information corresponding to a matched part of the hash values received from the DS of the execution side device.

14. A DS cooperation method comprising:
receiving an inquiry based on a request for combining a plurality of pieces of data from an integration server;
extracting data from a DB on the basis of the received inquiry;
generating a hash value based on the extracted data;
switching the status of the DS between a base point side device for transmitting the hash value generated by its own device to another DS that has received the inquiry from the integration server, and an execution side device for collating a hash value generated by the other DS that has received the inquiry from the integration server with the hash value generated by its own device by communicating with the other DS that has received the inquiry from the integration server;
receiving, in a case that the status of the DS is the execution side device, a hash value from a DS of the base point side device, collating the hash value generated by its own device with the received hash value, transmitting a collation result and data serving as a source of a matched part of the hash values to the integration server, and transmitting the matched part of the hash values; and
transmitting, in a case that the status of the DS is the base point side device, the hash value generated by its own device to a DS of the execution side device and transmitting the extracted data to the integration server on the basis of information corresponding to a matched part of the hash values received from the DS of the execution side device.

15. A DS cooperation program for causing a computer to:
receive an inquiry based on a request for combining a plurality of pieces of data from an integration server for combining data;
extract data from a DB on the basis of the received inquiry;
generate a hash value based on the extracted data;
switch the status of the DS between a base point side device for transmitting the hash value generated by its own device to another DS that has received the inquiry from the integration server, and an execution side device for collating a hash value generated by the other DS that has received the inquiry from the integration server with the hash value generated by its own device by communicating with the other DS that has received the inquiry from the integration server;
receive, in a case that the status of the DS is the execution side device, a hash value from a DS of the base point side device, collate the hash value generated by its own device with the received hash value, transmit a collation result and data serving as a source of a matched part of the hash value to the integration server, and transmit matched part of the hash values to the DS of the base point side device; and
transmit, in a case that the status of the DS is the base point side device, the hash value generated by its own device to a DS of the execution side device and transmit the extracted data to the integration server on the basis of the matched part of the hash values received from the DS of the execution side device.
